(19) United States
(12) Patent Application Publication
(10) Pub. No.: US 2018/0141277 A1
(43) Pub. Date: May 24, 2018

(54) Method and Apparatus for Partitioning a Material

(71) Applicants: Benjamin P. Warner, Los Alamos, NM (US); Francesco de Rege Thesauro, Acton, NM (US)

(72) Inventors: Benjamin P. Warner, Los Alamos, NM (US); Francesco de Rege Thesauro, Acton, NM (US)

(21) Appl. No.: 15/706,719

(22) Filed: Sep. 17, 2017

Related U.S. Application Data
(60) Provisional application No. 62/425,559, filed on Nov. 22, 2016.

(51) Int. Cl. B29C 64/30; B33Y 50/02; B29C 64/124; B29C 64/209

(52) U.S. Cl. CPC B29C 64/30; B33Y 50/02; B29C 64/40; B29C 64/209; B29C 64/124

(57) ABSTRACT

Methods and apparatus are described for depositing materials at a precise location. The deposition is accomplished by using CNC control and a nozzle guide.

### RELATED APPLICATIONS/CLAIM OF PRIORITY

This application claims any and all benefits as provided by law, including the benefit under 35 U.S.C. § 119(e) of U.S. Provisional Application No. 62/425,559 filed Nov. 22, 2016 which is herein incorporated by reference in its entirety.

### FIELD OF THE DISCLOSURE

The present disclosure relates generally to accurately dispensing materials, and in particular, the portioning of materials to a specific deposition position using CNC positioning and a guide.

### BACKGROUND OF THE INVENTION

3-D printing is an additive manufacturing process that builds a part in a layer-by-layer fashion to create a three-dimensional object from a digital model. Initially developed in the mid 1980's and used subsequently in highly specialized industries with the expertise and financial means to mitigate the high costs, 3-D printing has recently become a technology that is cheap and accessible to almost anyone. Today's 3D printers include room sized systems but are more typically desktop instruments and can be used for creating and/or prototyping items as disparate as human organ replacements and turbine parts.

Precise placement of material using 3-D printing on a part or in a receptacle that is located at a specific position on the print bed requires tedious and time-consuming alignment and/or very precisely and expensively machined holders for the part. There therefore is a need for 3D printers and methods of printing that can be both precise and do not need the heretofore mentioned alignment and/or holders.

### SUMMARY

In general, methods, equipment and systems are described herein for accurately dispensing materials to a specific area on a surface, on a part and/or through a small opening into a receptacle. For example, a material can be deposited on a part with minimal alignment of the part relative to a dispensing nozzle.

In accordance with the invention there is provided a 3D printer comprising a nozzle guide and a nozzle. The nozzle has a flexible portion and a non-flexible portion. The nozzle also has an extruding end which comprises a part of the non-flexible portion. The nozzle guide can be fixed to the non-flexible portion of the nozzle. The 3D printer can optionally include a stage disposed to receive material extruded from the extruding end of the nozzle and wherein the nozzle guide is fixed to the stage. In some implementations, the 3D printer further includes a deposition location determined at least in part by CNC control and wherein the nozzle guide can adjust the nozzle position. For example, the CNC control can bring the nozzle to a certain position and the nozzle guide can adjust the position. Optionally, the 3D printer further comprises a receptacle wherein the deposition location is through an opening of the receptacle and within the receptacle. For example, the nozzle can be brought to a position proximate to the opening, or past an opening and material is extruded through the nozzle out of the nozzle wherein it drops to the bottom of the container. Optionally, the 3D printer further comprises a fixture for holding the receptacle. For example, the fixture holds the receptacle down against a relative upward force imparted by the nozzle in a direction perpendicular to the stage. For example, the stage can move down away from the nozzle and/or the nozzle can move up away from the stage. Optionally the receptacle is dimensioned to be larger at the outer diameter of its base than at a position above the base, and the fixture comprises holes with a maximum diameter that is smaller than the outer diameter of the base. Also, optionally, the receptacle is screwed into the fixture. In some implementations, the coefficient of friction between the receptacle and fixture surface in contact with the receptacle is at least 0.1 (e.g., at least 0.2, at least 0.3, at least 0.4, at least 0.5 at least 0.6, at least 0.7, at least 0.8, at least 0.9). Optionally, the nozzle guide is attached to the fixture. In some implementations, the 3D printer further includes a chamber for containing a material, wherein the chamber is in fluid communication with the nozzle. Optionally, the flexible portion of the nozzle includes at least a portion of the chamber. In some implementations, the printer further comprises a heater disposed to heat the chamber. In some implementations, the 3D printer further includes a heater disposed to heat the nozzle. Optionally the nozzle further comprises a valve for controlling the flow of material therethrough. In some implementations, the nozzle guide includes an inner taper. In some implementations, the nozzle guide includes an outer taper.

Also in accordance with the invention there is provided a 3D printer for extruding material into a receptacle. The printer includes: a chamber capable of containing the material, the chamber comprising at least one movable wall; a mechanism for moving the wall, the mechanism being CNC controlled; an opening in the chamber through which the material can pass; a nozzle in fluid communication with the opening in the chamber and with an end for accepting the material from the chamber and an extruding end for extruding the material; a receptacle opening for receiving the extruded material into the receptacle; a stage for holding the receptacle, wherein relative movement of the nozzle and stage are CNC controlled; and a nozzle guide disposed to move the extruding end of the nozzle to the receptacle opening. The nozzle can optionally be attached to the nozzle. Optionally the nozzle guide is attached to the stage. Optionally, the nozzle guide comprises a part of the receptacle. In some implementations, the nozzle guide comprises a tapered portion. Optionally, the 3D printer includes a fixture on the stage for placement of the receptacles therein. For example, the receptacle and fixture can be dimensioned so that the receptacle is held down against relative upward movement of the nozzle (e.g., movement wherein the nozzle moves away from the stage and or movement wherein the stage moves away from the nozzle). In some implementations, the nozzle comprises a flexible portion and a rigid portion. Optionally, the rigid portion is rigidly fixed to the nozzle guide (e.g., so that the nozzle and nozzle guide do not move substantially relative to each other, such as less than about 1 mm, less than about 0.1 mm, less than about 0.01 mm or even less than about 0.001 mm). Optionally, the flexible portion is connected to the chamber opening. In some implementation of the 3D printer, the chamber comprises a flexible portion and wherein the flexible portion is proximate to the opening of the chamber. For example, the chamber can be configured as a syringe where the tip of the syringe where the nozzle is attached can flex and move. Optionally, the nozzle guide comprises a tapered outer portion. Optionally, the receptacles are arranged as a two dimensional array on the stage.

Also in accordance with the invention there is provide a method of depositing material using a 3D printer. The method comprises adjusting the position of the extruding opening of a nozzle to a desired position using a nozzle guide. For example, the position of the nozzle without the nozzle guide can be CNC controlled and the control does not align the extruding nozzle to the desired location due to misalignment of the nozzle relative to, for example, a container. With use of the nozzle guide, the position is adjusted to the desired position. Optionally the extruding opening of the nozzle moves. In some implementations, the desired deposition position is determined at least in part by CNC control. Optionally, the nozzle bends due to the nozzle guide and movement that is CNC controlled. Optionally, the nozzle guide engages a feature proximate to the desired deposition position. For example, the feature can be the outer walls of a receptacle at a position proximate to the receptacle opening and distal from the receptacle base. Optionally the nozzle guide engages the feature at an inner taper. Optionally, the material is deposited into a receptacle having an opening. Optionally the receptacle is held onto a stage against relative movement in a direction perpendicular to the stage. In some implementations, the nozzle guide comprises a part of the receptacle. Optionally, the nozzle guide is attached to a stage. In some implementations of the method the material comprises a cannabis extract. For example, the cannabis extract can be selected from the group consisting of cannabigerolic acid (CBGA), cannabichromene acid (CBCA), cannabidiol acid (CBDA), Δ⁹-tetrahydrocannabinolic acid (THCA), cannabinol acid (CBNA), cannabigerol (CBG), cannabichromene (CBC), cannabidiol (CBD), Δ⁹-tetrahydrocannabinol (THC), cannabinol (CBN) and mixtures of these. In some implementations of the method the material comprises a terpene. For example, the terpene can be selected from the group consisting of Pinene (e.g., alpha-Pinene, Beta-Pinene), Myrcene, Limonene, Caryophyllene, Linalool, Terpinolene, Camphene, Phellandrene, Humulene, Phellandrene, Phytol, Pulegone, Bergamotene, Farnesene, Delta-3-Carene, Elemene, Fenchol, Aromadendrene, Bisabolene, alpha-Bisabolol, Borneol, Euclyptol, Cineole and mixtures of these.

The apparatus described herein can be used for dispensing materials that are liquids and viscous pastes onto or into parts precisely and accurately. For example, the materials can be dispensed at specific geometric locations such as through a small aperture, in a small groove or confined to a specific area of a part. This can be done without resorting to sub millimeter alignment of the part relative to the dispensing equipment.

Other features and advantages of the invention will be apparent from the following drawings, detailed description, and from the claims.

### DESCRIPTION OF THE DRAWINGS

The foregoing will be apparent from the following more particular description of example embodiments of the invention, as illustrated in the accompanying drawings. The drawings are not necessarily to scale, emphasis instead being placed upon illustrating embodiments of the present invention.

FIG. 1 is a highly diagrammatic cross cut front view of an apparatus with a nozzle guide for dispensing a material.

FIGS. 2A, 2B, 2C, 2D and 2E illustrate how the nozzle guide adjusts the positioning of a nozzle and/or a receptacle.

FIG. 3 shows how the nozzle guide operates as a sequence of steps A, B, C, D and E or A, B, C, D and F.

FIG. 4A shows a 3D view of a nozzle.

FIG. 4B shows a top down view of a nozzle.

FIG. 5A shows a 3D view of a nozzle guide,

FIG. 5B shows a side view of a nozzle guide.

FIG. 5C shows a top view of a nozzle guide

FIG. 5D shows a bottom view of a nozzle guide.

FIGS. 6A and 6B show a nozzle and nozzle guide assembly as a 3D view.

FIGS. 7A and B show 3D views of a fixture and a receptacle.

FIGS. 8A and B show how a nozzle, nozzle guide, receptacle and fixture interact.

FIGS. 9A, 9B, 9C, 9D, 9E, 9F, 9G, and 9h show 3D views of embodiments of receptacles and a fixture.

FIGS. 10A and 10B show an embodiment wherein the nozzle guide is part of a receptacle. FIG. 10A is a cross cut side view. FIG. 10B is a 3D view.

FIGS. 11A and 11B show an embodiment wherein the nozzle guide can be placed on a stage of a 3D printer. FIG. 11A is a cross cut side view. FIG. 11B is a 3D view of the nozzle guide.

### DETAILED DESCRIPTION

### Glossary

As used herein, CNC control refers to computer numerical control. For example, where the motions of a machine are controlled by a prepared program containing coded alphanumeric data such as G-code. CNC control can control the position and motion of a nozzle and stage of an additive manufacturing machine relative to each other (e.g., their relative x, y, and z position). Other energy outputs (e.g., heating, cooling, and electrical power to a laser), monitoring of weight on a printer bed, optical feeds from digital cameras and speed of extrusion of a feedstock can also be CNC controlled.

As used herein, a linear actuator refers to an actuator that creates motion in a straight linear path.

As used herein; x, y and z (lower case) are Cartesian coordinate points. X, Y and Z (Upper case) refer to the Cartesian directions and Rₓ, R_{y} and R_{z} are rotational directions about the subscripted axis. Clearly, other coordinate systems can be used by applying the appropriate transfer function, e.g., to polar coordinates.

As used herein, viscosity is a measure of a liquid's resistance to deformation by shear or tensile stress. Low viscosity liquids have a viscosity of less than about 10,000 centipoise (cP) and can be poured (e.g., up to about the consistency of honey at room temperature). Medium viscosity liquids have a viscosity between about 10,000 centipoise and about 1,000,000 centipoise (e.g., pastes including ketchup and peanut butter) and can be extruded with moderate force but cannot be easily poured. High viscosity liquids have viscosity above about 1,000,000 centipoise and are pastes or putties that cannot be poured (e.g., Caulking compounds between about 2 and 5 million cP, window putty more than 100 million cP).

As used herein, Young's Modulus is the slope of a stress strain curve for a material in the elastic (e.g., linear) region. Young's Modulus is the ratio of compressive stress to the longitudinal strain and is an indication of a material's stiffness. Stiff materials have a higher Modulus than a flexible material.

As used herein, resilience is the ability of a material to absorb energy when it is deformed elastically, and release that energy upon unloading.

### Embodiments

Using the equipment, methods and systems described herein, and illustrated in the figures, a material can be precisely and accurately dispensed onto and/or into a part. For example, a 3D printer with a nozzle guide can be used to dispense a liquid material into an arrayed set of containers precisely and accurately.

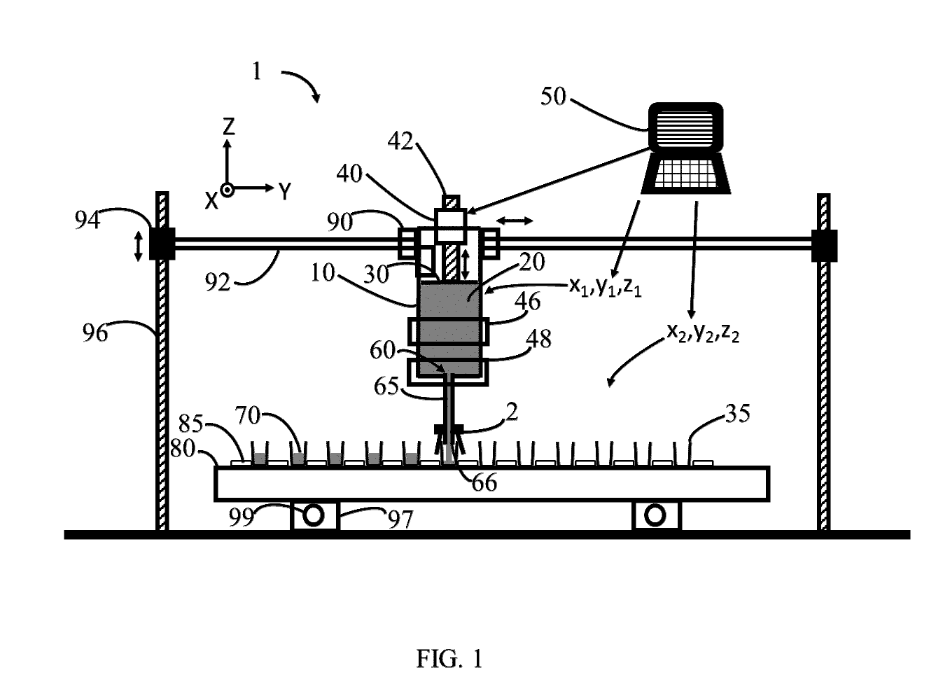

FIG. 1 is a highly diagrammatic cross cut front view of an apparatus 1 with a nozzle guide 2 for dispensing a material. The apparatus includes a chamber 10 capable of containing a material 20. The chamber includes at least one movable wall 30. The wall can be made to move by a mechanical device 40 (e.g., a stepper motor) coupled to a screw 42 and nut (e.g., components of a linear actuator) in mechanical communication with the wall. For example, the wall can be made to move up and down in the Z direction as indicated by the double headed arrow next to screw 42. The device 40 can be controlled by a CNC controlling device 50 such as a computer executing an algorithm, and using an appropriate intermediate hardware (e.g., an Arduino motherboard). The chamber 10 also includes at least one opening 60 through which material 20 can be extruded. A nozzle 65 can be attached to the opening and provide a fluid path from inside the chamber to outside of the chamber. The material 20 can be extruded out of chamber 10 through the opening of the nozzle 66 (e.g., the extruding end) and deposited as extruded material 70 (e.g., having the same composition as 20).

A stage 80 can hold receptacles (e.g., partitionable receptacles)/parts 35 (e.g., such as containers) and the receptacles can receive the extruded material from the nozzle (e.g., a first layer of extruded material is deposited in the receptacle 35 with subsequent layers deposited on previously deposited material). The stage 80 can provide a flat surface for placement of the parts, and/or the stage can be configured with holders/fixtures 85 (e.g., as part of the stage or as a separate item attached to the stage) for placing and/or holding the containers in specific locations. For example, the fixture can include indentations or holes that the parts fit in. The fixture can hold the receptacles in a two dimensional array on the stage. Guiding lines or features can also be scribed, etched, drawn, or built on the stage to indicate where parts should be placed. Containers that can be used in the apparatus include cartridges (e.g., vaporizing pen cartridges), capsules (e.g., medicinal and herbal capsules), and bottles (e.g., 0.5 mL to 100 mL bottles). The relative position of the stage 80 and the opening 60, nozzle 65 and extruding end 66 is controlled by the CNC control. Precise positioning of the partitionable receptacle 35 and nozzle opening 66 is controlled by the CNC control, the fixture(s) and the nozzle guide 2. For example the CNC control can bring the nozzle to the approximate desired x and y deposition location (e.g., within 1 cm, within 0.5 cm, within 4 mm, within 2 mm, within 1 mm the desired x and y location) and the nozzle guide can adjust the position more precisely relative to the receptacle (e.g., moves the nozzle, adjusts the movement of the nozzle, adjusts the location of the nozzle; or moves the receptacle, adjusts the movement of the receptacle, adjusts the location of the receptacle) to the desired location (e.g., within about 2 mm, within about 1 mm, within about 0.5 mm or even within about 0.1 mm of the desired x and y location). The stage can be heated (e.g., up to about 120 degrees Celsius) and/or cooled (e.g., down to about −40 degrees Celsius). The stage or a tray (e.g., holders) placed on the stage can also optionally be tilted, for example between 0 and 90 degrees relative to the xy plane and in any direction (e.g., between 2 and about 60 degrees, between about 5 and about 45 degrees, between about 10 and about 20 degrees such as 1, 2, 3, 4, 5, 6, 7, 8, 9, 10, 11, 12, 13, 14, 15, 16, 17, 18, 19, 20 degrees). This tilt can be useful, for example, in tilting containers relative to the nozzle and can aid in aligning the nozzle into a container in some container configurations (e.g., wherein there is a post or other obstacle in the container the nozzle must accommodate) and can be implemented with or without the nozzle guide and with or without any other feature described herein.

The nozzle can include a valve to help control the flow of material. The valve can be pressure controlled, for example, the valve can be configured to open when wall 30 compresses material 20 and the valve closes when the wall 30 retracts. The valve can also be CNC controlled, for example the valve can be set to open when the wall 30 moves in a direction to compress material 20 and the valve can be set to close when the wall 30 is not moving, for example right after wall 30 stops moving or at a time after the wall stops moving (e.g., between about 1 and 30 seconds after, between about 1 and 20 seconds after, between about 1 and 10 seconds after, between about 1 and 5 seconds after).

A multi-zone temperature controlling apparatus can be used to heat or cool the chamber and/or nozzle. For example, a multi-zone temperature control apparatus with zones 46 and 48 can be included with apparatus 1. The multi-zone temperature control apparatus can include two or more zones (e.g., three, four, five or more zones). The temperatures of each zone can be independently set to any desired temperatures. For example, any temperatures between about −50 and 400 degrees Celsius, with control in each zone of about +/−0.1 degrees Celsius. The temperature control apparatus can be configured with heaters and/or coolers. For example, the heaters can be heating tape that contacts the chamber, a conducting metals in contact with the chamber and a heating cartridge, a hot air gun directed at the chamber, an IR lamp directed at the chamber, a heating jacket with a heating fluid passing therethrough (e.g., heated water, heated oil, heated air), a resistive heater embedded in a flexible rubber (e.g., a flexible silicone rubber insulated heater), or any radiative heater in proximity to the chamber. The entire chamber can be heated or a portion of the chamber can be heated. In some embodiments, the heater directs heat near the outlet of the chamber such as at a nozzle attached to the chamber. In some embodiments, the chamber includes an insulated portion distal from the opening and a heat conductive portion proximal to the opening. The heaters can provide temperatures between ambient temperature and about 400 degrees Celsius (e.g., less than about 110 degrees Celsius). Coolers can be a fan, a radiator and/or a cooling jacket with a cooling fluid passing therethrough (e.g., cooling water, chilled air and chilled gas such as nitrogen). The heating and/or cooling of the zones is controlled by the CNC control. The temperature is monitored, for example by a thermistor or thermocouple integrated with each of the zones or in the chamber proximate to the heating zone, an IR heat detector directed at the chamber and/or nozzle or any other useful heat monitoring device (e.g., a thermometer).

The CNC control communicates with electrical and mechanical devices that control the relative position of the chamber 10 (e.g., x₁, y₁, z₁) and of the stage 80 (e.g., x₂, y₂, z₂). In addition, the CNC control communicates with the mechanism 40 and thus the extrusion rate out of opening 60 and nozzle 65. For example, extrusion rates can be controlled between about 1 mg/s and about 1000 mg/s for a nozzle aperture size of about 2 mm (e.g., between about 0.2 mm and about 3 mm). Larger systems with larger nozzles can extrude material at a faster rate. The CNC control also controls the temperature of the multi-zone temperature control apparatus as previously described. For example, the CNC controls stepper motors coupled to the stage or chamber through direct screw drives, belts and or pulleys. Gantries, tracks and other methods of smooth movement of the stage and/or chamber relative to each other in X, Y and Z directions can be used. One preferred algorithm executes a relative X and Y movement of the opening/nozzle to the stage while extruding material at a specified rate, optionally followed by an incremental movement up in the Z direction, and deposition of another layer by relative movement in the X and Y directions. The algorithm may include pauses in motion, and motions in any direction. Such motions can be used to allow inspection, adjustment, modification, or other actions to be performed on the material being extruded or the apparatus. It is understood that the relative movement of the chamber and stage can be achieved by many different configurations. For example, under CNC control and the electrical and mechanical devices, the stage may move in the X and Y direction and the chamber moves in a Z direction; in another configuration, the stage may move in a Z direction and the chamber moves in an X and Z direction; alternatively, the stage may move in a Y direction while the chamber moves in an X and Z direction; in another option the stage may not move and the chamber may move in X, Y and Z directions. The exact configuration for CNC movement can be selected by the Artisan. In some embodiments such as depicted in FIG. 1, the chamber can be relatively heavy since it supports all of the feed material and linear actuator. Therefore, it may require a strong and rigid structure made of metal (e.g., aluminum and/or steel).

FIG. 1 shows one possible configuration for movement using a gantry to move the chamber relative to the stage. The gantry has a carriage 90 that is fastened to the chamber. The carriage can move in the Y direction on rail 92. The rail is fastened to nut 94 which is coupled to screw 96 and therefore can move the chamber in the Z direction. Movement of the carriage and screw can be done using stepper motors coupled to the carriage and screw (e.g., direct drive for the screw, through a belt for the carriage). The stage can be moved in the X direction with a second carriage 97 and rail 99. Other configurations include a stage that does not move and a gantry with 3 orthogonal rails to move the chamber in X, Y and Z directions are conceived.

As previously described, the movable wall 30 can be moved by means of a linear actuator that is in mechanical communication and/or in contact with the wall. For example, as shown in FIG. 1, the actuator is in contact on one side of the wall while the other side is in contract with the material. Although a screw and nut is depicted in FIG. 1, any suitable linear actuator can be utilized. Preferably the linear actuator can be selected from the group consisting of a screw and nut, a pneumatic or hydraulic piston, a solenoid, a wheel and axle or a cam. For example, by rotation of an actuator nut relative to a screw, the screw can move in and out of the threaded hole in a linear fashion (e.g., or the nut moves up or down the shaft). In an alternative, a wheel and axle can be coupled to a belt that is also connected to a rigid shaft and can move the shaft in a linear fashion. Also, a cam can be used to provide thrust at the base of a shaft.

Mechanisms other than a linear actuator are recognized for moving the walls of the chamber. For example, the Tube-Wringer® (Gill Mechanical Co., Oregon) acts by squeezing two walls of a flexible tube (e.g., configured as a toothpaste or caulking tube) between rollers. Such rollers could be modified to be driven by a motor and CNC controlled. Alternatively, more than one linear actuator could be used, for example, pushing on two walls of the chamber, such as opposing sides of a flexible tube.

The equipment, methods and apparatus herein preferably have very little dead volume. That is, at least 90 vol. % (e.g., at least 95 vol. %, at least 99 vol. %) of the contents (e.g., 20 in FIG. 1) in the chamber (e.g., 10) can be extruded out through the nozzle.

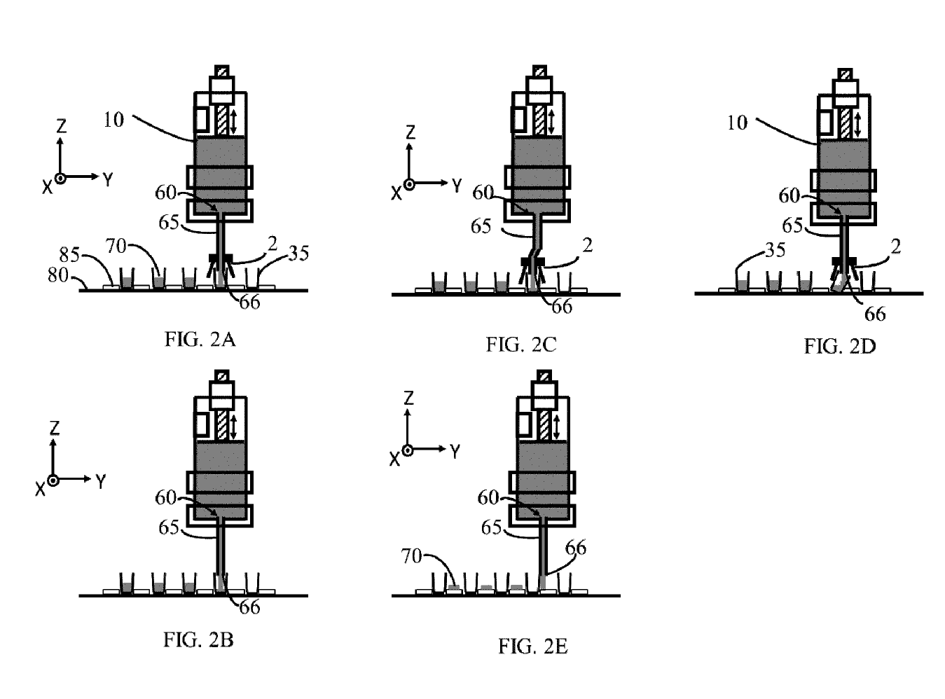

FIGS. 2A, 2B, 2C, 2D and 2E illustrate how in the embodiment illustrated by FIG. 1 the nozzle guide adjusts the positioning of the nozzle and/or the receptacle (e.g., moves the nozzle and/or receptacle). This facilitates dispensing material into a receptacle. FIG. 2A shows part of FIG. 1 including nozzle 65, nozzle guide 2, fixtures 85, stage 80 and receptacles 35. The chamber opening 60, nozzle 65, extruding end of the nozzle 66 and receptacles are aligned and material can flow from the chamber into the receptacle. FIG. 2B is similar to FIG. 2A but there is no nozzle guide. Since the chamber opening, nozzle, nozzle opening and receptacles are aligned in FIG. 2B the material can flow from the chamber into the receptacle. In FIGS. 2C and 2D the chamber opening and container are not aligned. However, the extruding end of the nozzle and the receptacle are aligned. In FIG. 2C this alignment is achieved with the nozzle bending to accommodate the misalignment between the opening of the chamber and the receptacle. In FIG. 2D the alignment is achieved with the receptacle moving. In some embodiments the receptacle and fixtures 85 can move. Therefore, as depicted in FIGS. 2C and 2D, material flows from the chamber into the receptacle even though the nozzle and receptacle were initially misaligned. Therefore, by alignment, when referring to the extruding end of the nozzle and the container opening, it is meant that the positions of the extruding end of the nozzle and the container are such that substantially all of the extruding material is delivered into the container (e.g., at least 95 vol %, at least 99 vol %). FIG. 2E depicts a configuration without a nozzle guide where the nozzle opening and receptacle are not aligned and material does not flow into the receptacle. Alternatively, misalignment of the nozzle opening and receptacle can cause the nozzle to be driven into the receptacle edge damaging the receptacle and or nozzle in addition to dispensing material in undesired locations. In some embodiments the nozzle, receptacle and/or fixtures can move e.g., the nozzle and the receptacle both move to achieve alignment so that the material flows into the receptacle.

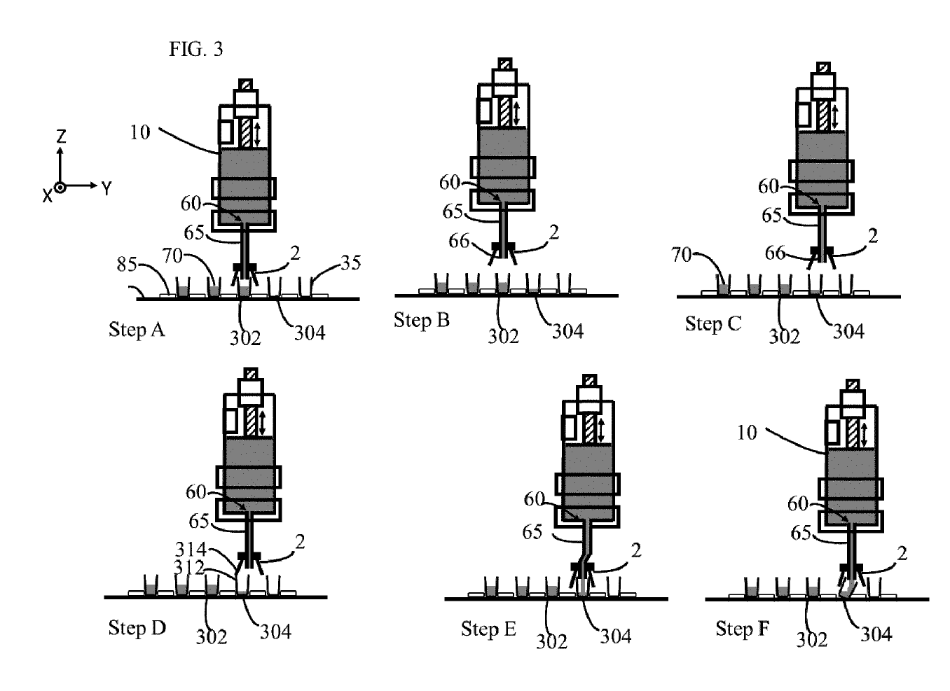

FIG. 3 shows how the nozzle guide operates as a sequence of steps A, B, C, D and E, or in the alternative as steps A, B, C, D and F. The figures are for the same embodiment as depicted for FIG. 1. Step A depicts a part of the filling process wherein the receptacle 302 (which is a subset of receptacles 35) has been filled and material dispensing from the nozzle opening has stopped. Step B depicts a part of the process wherein the chamber and attached apparatus has been lifted up in the Z direction so that the nozzle and nozzle guide is clear of the receptacle opening. Step C depicts a part of the process wherein the chamber and attached apparatus has been moved in the positive Y direction above the receptacles. In step C the nozzle opening 60 and receptacle 304 are misaligned in the Y direction. Step D depicts a part of the process wherein the chamber and attached apparatus is brought down towards receptacle 304 and the top of the receptacle 312 contacts the tapered inner edge 314 of the nozzle guide. Movement of the nozzle and nozzle guide further down leads to the situation shown in step E wherein the nozzle 65 bends so that the nozzle opening 66 aligns with the receptacle 304 and it is filled. Therefore, the nozzle guide can operate by moving and/or adjusting the nozzle extruding end to the desired deposition location such as the opening of a receptacle. It is understood that movement is supplied by the motors and actuators of the 3D printer under CNC control and the nozzle guide adjusts the direction of movement of the nozzle in relation to the desired deposition location. Thus, the nozzle guide movement can be equated to nozzle positioning adjustment. In addition to moving/adjusting and/or bending the nozzle, the nozzle guide can also move/adjust and/or bend the receptacle. Alternate step F occurs if the receptacle rather than the nozzle moves. Alignment between the nozzle extruding end and the receptacle opening also occurs in step F. A combination of steps E and F can occur, e.g., wherein both the nozzle and the receptacle move. The alternative wherein the fixture moves is not shown but is understood to be another alternate embodiment. The fixture, nozzle and/or receptacle can also move in further embodiments.

In some embodiments, the nozzle opening and nozzle guide are fixed relative to each other and a portion of the nozzle or the chamber is flexible. Flexibility can be accommodated by any useful means such as by construction using a flexible materials such plastics or reinforced plastics (e.g., with carbon fibers, glass).

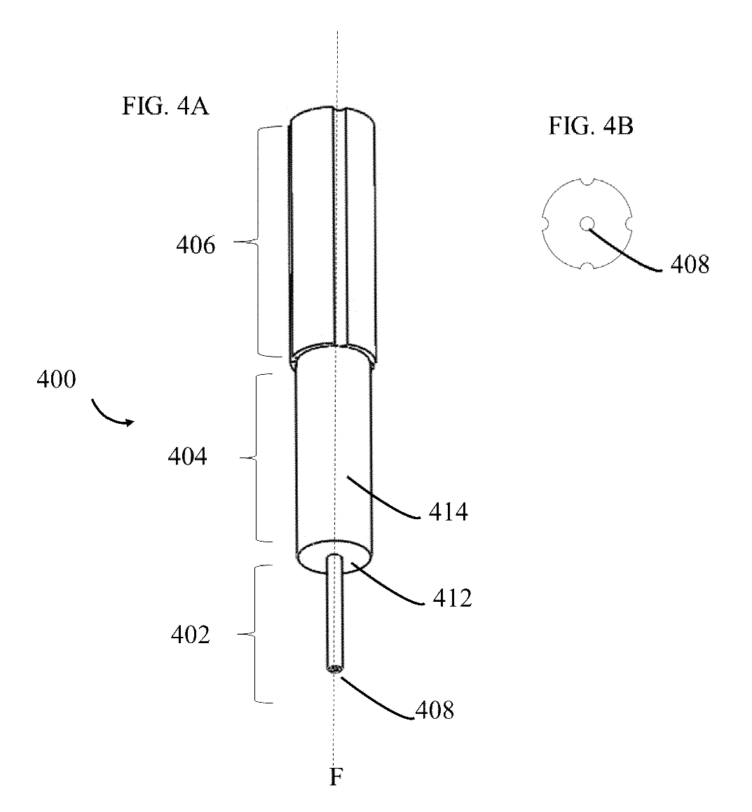

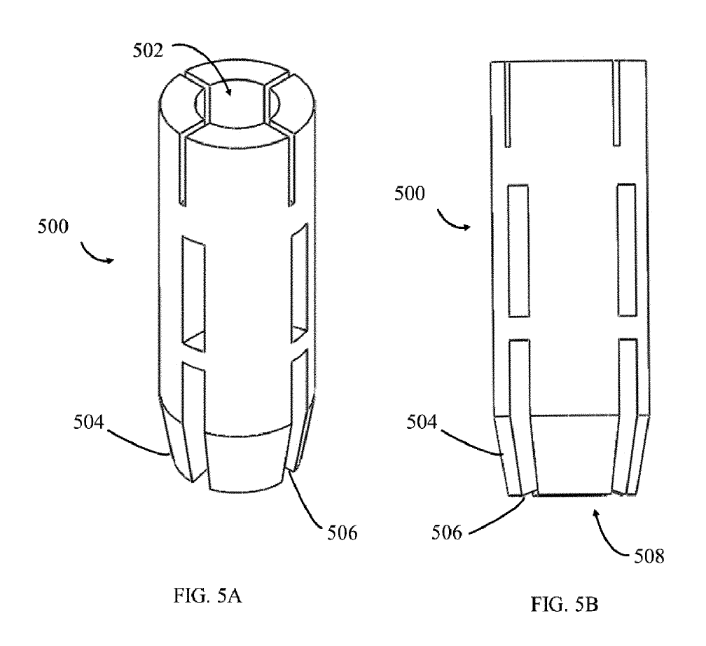

FIG. 4A shows a 3D view of a possible configuration of a nozzle 400. The nozzle has a lower narrow portion 402, a middle portion 404 and a top portion 406. The nozzle includes a through-hole 408 collinear with axis F. The narrow portion 402 is the extruding end of the nozzle, wherein extrudate comes out of the through-hole. A top view of the nozzle is shown by FIG. 4B wherein the hole 408 that passes through the structure is shown. The hole can provide fluid communication from a reservoir (e.g., opening 60 of FIG. 1) and the bottom extruding end of the nozzle (e.g., 66 FIG. 1). The portions of the nozzle 402, 404 and 406 can be one integrated piece or can be two or three distinct pieces that are removably connected to each other (e.g., screwed together or held together by friction or other means such as a Luer taper system). The bottom and middle portion are rigidly held in relation to each other. The middle portion engages the needle guide with surface 412 and 414. The top portion 406 is flexible, being able to bend from the axial position (indicated with dashed line F) from between 0.1 degrees to about 20 degrees. For example, the top portion can have a lower modulus than the middle and/or bottom sections. The top portion can be part of the chamber. The top portion should also be resilient, returning to its original form after each deposition operation.

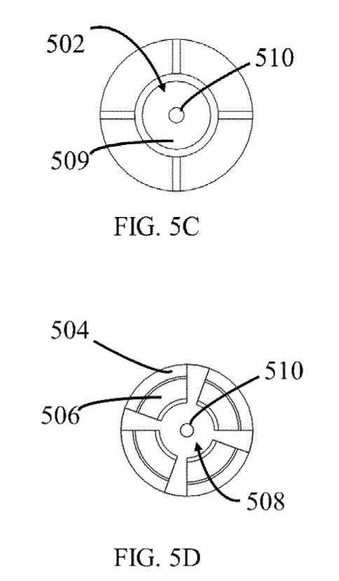

FIGS. 5A, B, C and D show a view of a nozzle guide 500. FIG. 5A shows a 3D view with a top opening 502 for accepting a nozzle. An outer taper at the bottom end 504 and inner taper 506 are shown. FIG. 5B shows a side view of the same nozzle guide. The outer taper at the bottom end 504 and inner taper 506 are shown. The bottom opening is indicted by 508. FIG. 5C shows a top view of the nozzle guide. The opening 502 is shown. The opening ends at a bottom with surface 509 wherein through-hole 510 with a smaller diameter than opening 502 is located, e.g., in the center of the surface. FIG. 5D shows a bottom view of the nozzle guide with the bottom opening 508, inner taper 506, and outer taper 504 and through-hole 510 indicated. When the nozzle and nozzle guide are assembled, the surface 509 and surface 419 (FIG. 4) are in contact and lower narrow portion 402 is threaded through through-hole 510.

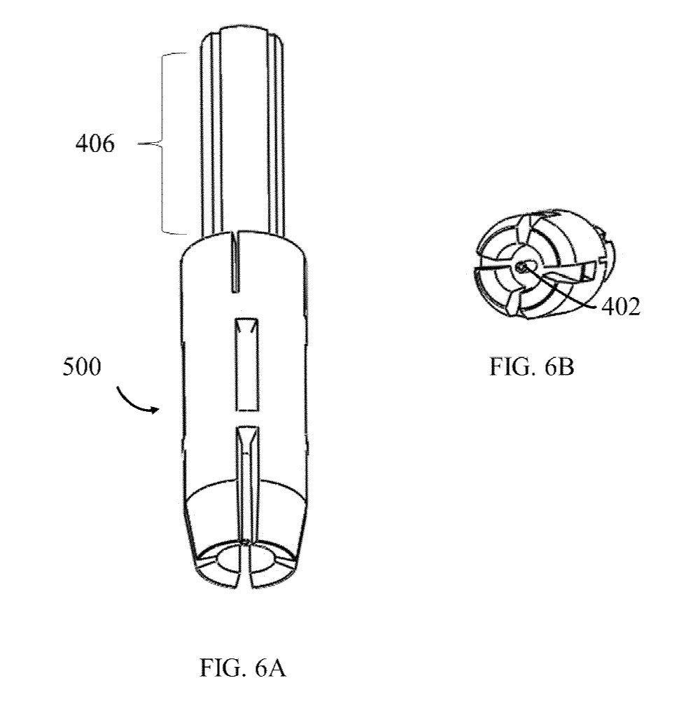

FIGS. 6A and 6B show the nozzle 400 assembled with nozzle guide 500 as two 3D views. FIG. 6B shows lower portion 402 of the nozzle that has been threaded through through-hole 510 of the nozzle guide.

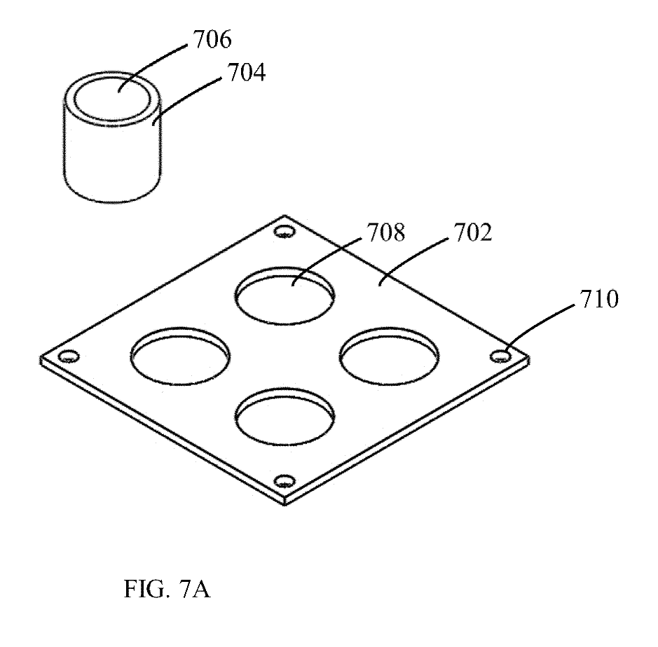

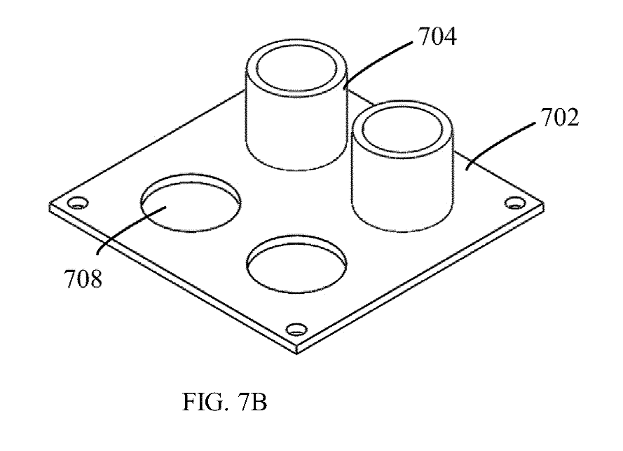

FIG. 7A shows a fixture 702 and a receptacle 704 with opening 706. The fixture has structures such as holes 708 or indentations configured to accept snug placement of the receptacle bottom. The fixture can be placed on a stage and attached thereto by any useful means. For example, the holes 710 can be used with bolts or set pins to attach the fixture to the stage. FIG. 7B shows fixture 702 with two receptacles 704 positioned in holes 708. The bottom of the container is supported by the stage since the holes 708 are through-holes. In embodiments wherein 708 is not a through-holes, the bottom of the hole can support the receptacles.

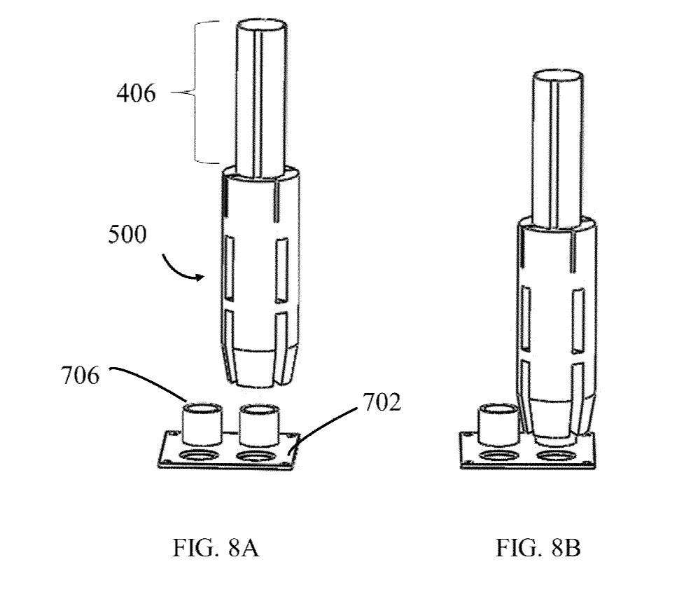

FIGS. 8A and 8B show how the nozzle, nozzle guide, receptacle and fixture interact. FIG. 8A shows the nozzle guide and receptacle prior to engagement and 8B shows engagement of the nozzle guide and the receptacle. In some embodiments, such as depicted by FIG. 8B, the nozzle guide can expand slightly as it slips around the receptacle. This can cause the guide to grab the receptacle which must be held by the fixture or it will be lifted up as the nozzle moves up in the Z direction (e.g., the relative movement perpendicular to the stage).

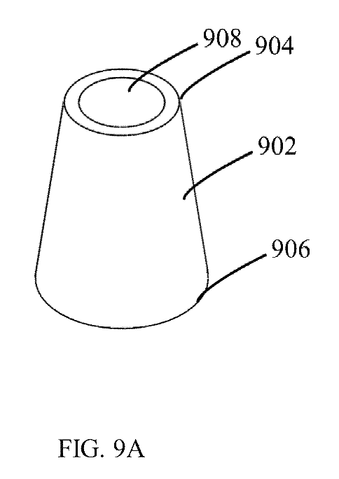

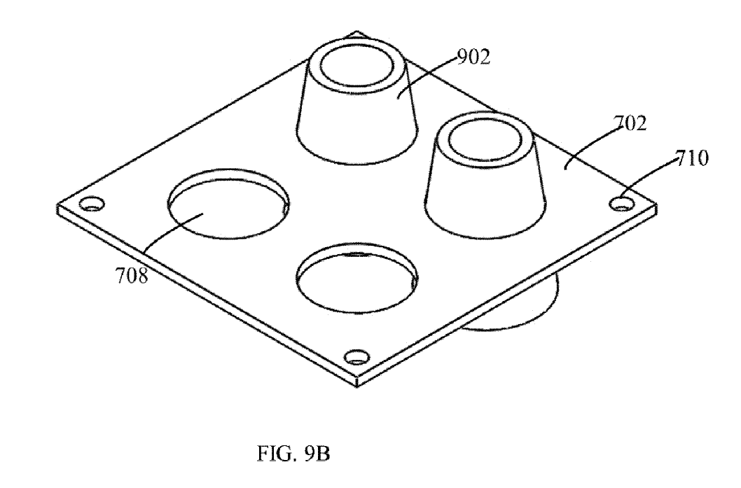

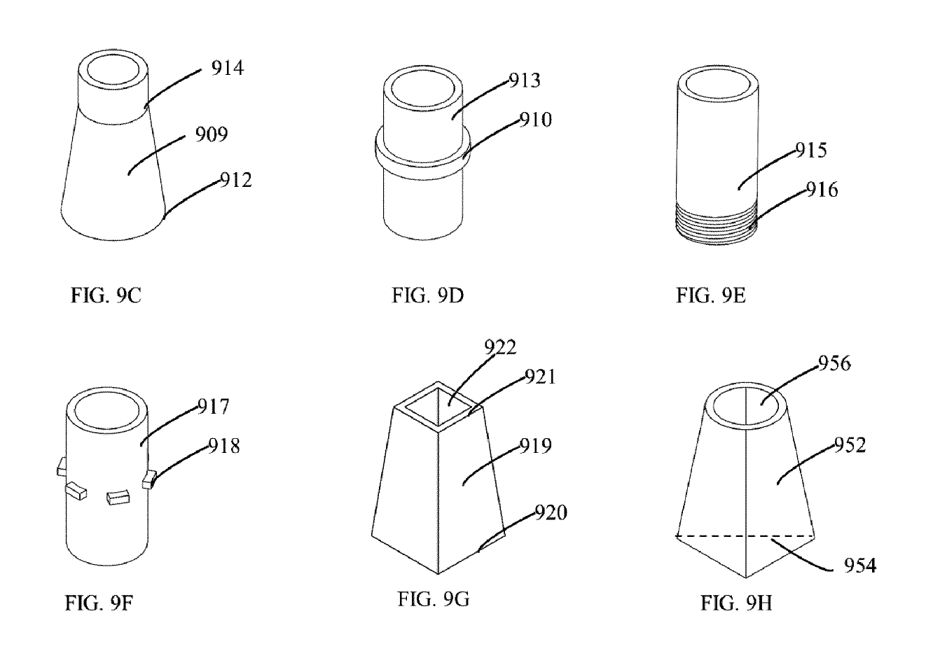

The receptacle can be held by the fixture by any useful means. For example, the bottom or base of the receptacle can be dimensioned to be larger than the top or any position above the bottom of the receptacle; and the fixture can have holes dimensioned to be a size between that of the size of the top and bottom (e.g., the maximum diameter or diagonal of the hole is sized larger than the base and smaller than the top or any position above the bottom of the receptacle). For example, shown in FIG. 9A is a receptacle 902 which is tapered. The top outer circumference 904 is smaller than the bottom outer circumference 906. The receptacle opening 908 is at the top. FIG. 9B shows two receptacles 902 that have been placed in fixture 702. The holes 708 are through holes with a circumference that is larger than circumference 904 and smaller than circumference 906. A bottom platform (not shown) can be attached, for example, using a bolt through 710. Other shaped receptacles can also be used, for example as shown by FIGS. 9C, 9D, 9E, 9F, 9G and 9H. In FIG. 9C, receptacle 909 has a middle outer circumference 914 is smaller than the circumference of the holes in a fixture (e.g., fixture 702 FIG. 9B) while the bottom outer circumference 912 is larger than the circumference of the fixture. In FIG. 9D, receptacle 913 has a circumferential feature 910 with a circumference that is larger than the circumference of the holes in a fixture (e.g., fixture 702 FIG. 9B). Shown in FIG. 9E, receptacle 915 has a bottom portion that is threaded 916 and the fixture would have tapped holes matched to the thread of the receptacle. Such a threading could occur at a position further up on the receptacle, e.g., between the base and top of the receptacle. Shown in FIG. 9F, receptacle 917 has circumferential features 918 that protrude from the outer surface of the receptacle to an extent that is larger than the diameter of the holes of a fixture (e.g., the holes of 708 in fixture 702 FIG. 9B). Other than cylindrical shapes can be used for the receptacles as shown in FIG. 9G wherein the receptacle 919 has square profiles with sides 920 at the base larger than sides 921 at the top so that the shape is a tapered rectangular prism with a square opening 922. For a receptacle such as 919, the fixture could have square holes with sides dimensioned between the sizes of 920 and 921. As shown by FIG. 9H receptacles can include a base with one profile and a top with another. The base diagonal of receptacle 952 indicated by the dotted line 954 at the bottom of the figure is larger than the outer diameter at the top 956 indicated by the dotted line at the top of the figure.

Alternatively or additionally, in some embodiments, the receptacle and fixture can be attached to each other by a matching latches and clips (e.g., toggle clamps, band clamps), hook and loop (e.g., Velcro®, Velcro, UK), magnetic fastening and/or interlocking features (e.g., LEGO™, The Lego Group, Denmark), vacuum (e.g., suction cups, a vacuum stage), fasteners (e.g., bolts and nuts). The receptacles themselves can be attached to each other by any method described herein and any other useful method to form a two dimensional array that can be placed on the stage. The fixture can be made of a material that can expand around the receptacle such as an elastic material and which has a high coefficient of friction between the receptacle surface and the contacting surface of the fixture e.g., having a kinetic coefficient of friction greater than about 0.1, greater than about 0.2, greater than about 0.3, greater than about 0.4, greater than about 0.5, greater than about 0.6, greater than about 0.7, greater than about 0.8 or even greater than about 0.9.

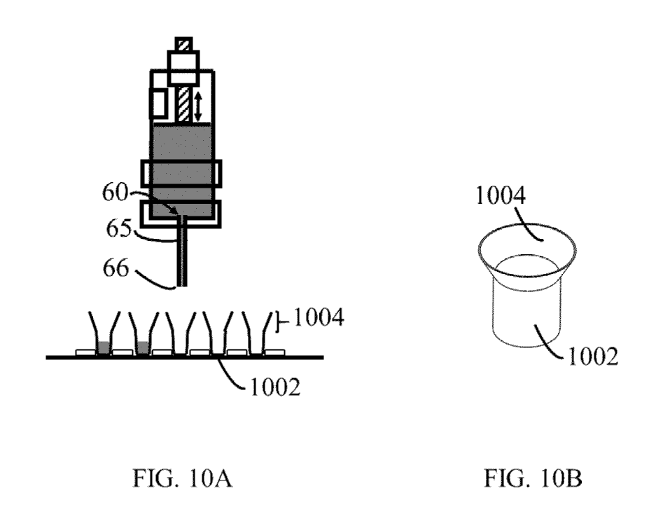

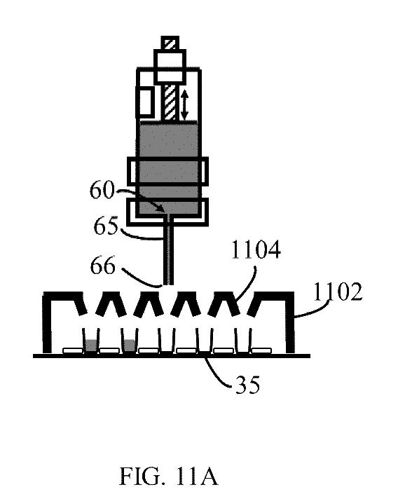

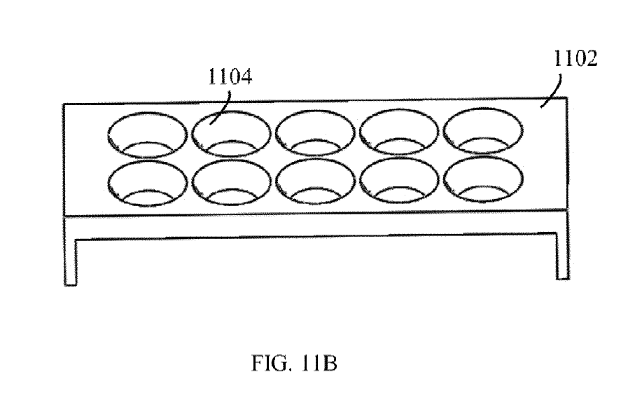

In another embodiment the nozzle guide is not attached to the nozzle. For example, as illustrated in FIGS. 10A and B, the receptacles 1002 can have a tapered inner portion 1004 that guide the nozzle such as the nozzle narrow bottom portion into the container. Alternatively, as shown in FIGS. 11A and B, the nozzle guide 1102 can be attached to fasteners or the stage and have inner tapers 1104 for guiding the nozzle to the desired deposition position as illustrated in FIGS. 11A and 11B.

In yet other embodiments combinations of the above nozzle guides can be used. For example the nozzle guide can include a guide attached to the nozzle such as illustrated in FIGS. 6A and B, and a guide that is not attached to the nozzle such as illustrated in FIGS. 10A, 10B, 11A and/or 11B. For example a nozzle guide can have an outer taper (e.g., 504 FIGS. 5A, B, C and D) and can have the taper depicted in FIGS. 10A and 10B, wherein the tapering work in concert to guide the nozzle extruding end to the receptacle opening. Alternatively, a nozzle guide that is attached to the nozzle works in concert with a nozzle guide that is attached to the stage and/or a fixture. The two nozzle guides can be considered as a single nozzle guide or a nozzle guiding system.

In some embodiments the outer taper can aid in guiding the nozzle by using receptacles that are neighbors to the receptacle being filled to direct the nozzle to the correct location. For example, wherein the receptacles are arranged in a 2D array in a fixture on a stage and the receptacles move together when engaged by the nozzle guide.

In preferred embodiments the chamber and movable wall are configured as a syringe, with the barrel of the syringe defining the chamber and the movable wall being the surface of the plunger placed inside the barrel. In optional embodiments the syringe is partially or completely disposable. For example, the syringe can include a lining, tube or a cartridge that is disposable. The nozzle can include part of the syringe proximate to attachment to the syringe.

In some embodiments, the nozzle can be configured as an assembly of Luer taper and screw together parts.

In some embodiments two or more chambers are used and each chamber feeds the material to be extruded through an opening in each chamber, to the nozzle inlets. Therefore, between the outlet of the chambers and the nozzle inlets the two materials combined prior to being extruded through the nozzle. The location or region where the combination occurs is an in-line mixer. For example, with two chambers, the mixer can be in a “Y”-shaped configuration wherein the mixing chamber has two inlets connected to the outlets of the chambers and one outlet connected to the nozzle inlet. The size of the inlets to the chamber can be each of different sizes, for example to control the amount of material from each chamber allowed into the mixing chamber. The chamber can be an elongated tube, elliptical, rectangular, conical or any other suitable shape. Mechanical mixing such as rotating propellers, paddles, rotor stators and/or turbines can be used to improve the mixing. Mechanical stationary means such as a static mixer can also be used. Preferably, a static in-line mixer is used. In other embodiments two or more chambers with each having a corresponding outlet, nozzle and nozzle guides can be utilized. In another embodiment, the chamber can have two or more openings and/or nozzles with nozzle guides for extruding material.

The materials that can be partitioned using the apparatus described herein include liquids with low medium and high viscosity. Preferably the materials have medium to low viscosities at room temperature. If the materials have a medium viscosity at room temperature, it is preferable the materials have a low viscosity at an elevated temperature (e.g., between about 40 and about 100 degrees Celsius, between about 40 and 80 degrees Celsius).

The embodiments include using materials that include cannabis extracts. There has been a growing interest and public acceptance of the use of cannabis for medicinal and recreational use. The plant material has been used for their therapeutic effects in treating the symptoms of cancer, aids, multiple sclerosis, pain, glaucoma, epilepsy and other conditions. In the plant, some of the active components include cannabigerolic acid (CBGA), cannabichromene acid (CBCA), cannabidiol acid (CBDA), Δ⁹-tetrahydrocannabinolic acid (THCA) and cannabinol acid (CBNA). These can be used in creams, eye drops, therapeutic patches, edible pills and by heating the material and inhaling the smoke such as through a cannabis cigarette or pipe. Heating cannabinoids decarboxylates the components described above producing cannabigerol (CBG), cannabichromene (CBC), cannabidiol (CBD), Δ⁹-tetrahydrocannabinol (THC) and cannabinol (CBN) and volatilizes the components. In addition to the above, cannabis extracts also include many other ingredients such as terpenes. For example; Pinene (e.g., alpha-Pinene, Beta-Pinene), Myrcene, Limonene, Caryophyllene, Linalool, Terpinolene, Camphene, Phellandrene, Humulene, Phellandrene, Phytol, Pulegone, Bergamotene, Farnesene, Delta-3-Carene, Elemene, Fenchol, Aromadendrene, Bisabolene, alpha-Bisabolol, Borneol, Euclyptol, Cineole and mixtures of these. In addition to smell and taste, these auxiliary components purportedly can provide synergistic medicinal properties. Excessive and/or prolonged heating of these terpenes can volatilize them removing them from the extract which can be detrimental to the efficacy of the extract.

The above extracts can be combined with other ingredients such as sugar, starch, oils, fats (e.g., vegetable fats) and jelly prior to portioning. In some embodiments, the materials are not heated above about 120 degrees Celsius while being extruded. For example, the material can be extruded at temperatures between about room temperature and 100 degrees Celsius (e.g., between about 40 and about 100 degrees Celsius, between about 40 and 80 degrees Celsius). In addition, preferably the material is not heated for prolonged periods of time, such as for less than about 30 min (e.g., less than about 20 minutes, less than about 10 minutes). Control of the temperature can avoid the decomposition and/or volatization of terpenes. For example, using a multi-zone temperature controller a chamber can be heated to a first temperature that avoids decomposition of terpenes but allow flow of material, and a nozzle can be heated to a higher temperature to provide better flow of the material and limited exposure of the material to the higher temperature. It is understood that, since the chamber/syringe holding materials is a closed system, loss of volatile materials is expected to be minimal until the material is extruded.

In some other embodiments, temperatures above about 110 degrees Celsius may be desired. For example, temperatures above 110 degrees can be utilized if decarboxylation of THC is desired.

What is claimed is:

1. A 3D printer comprising a nozzle guide and a nozzle, the nozzle having a flexible portion and a non-flexible portion and the nozzle having an extruding end which comprises a part of the non-flexible portion.

2. The 3D printer as in claim 1, wherein the nozzle guide is fixed to the non-flexible portion of the nozzle.

3. The 3D printer as in claim 1, further comprising a stage disposed to receive material extruded from the extruding end of the nozzle and wherein the nozzle guide is fixed to the stage.

4. The 3D printer as in claim 1, further comprising a deposition location determined at least in part by CNC control and wherein the nozzle guide can adjust the nozzle position relative to the deposition position.

5. The 3D printer as in claim 4, further comprising a receptacle and wherein the deposition location is through an opening of the receptacle and within the receptacle.

6. The 3D printer as in claim 5, further comprising a fixture for holding the receptacle.

7. The 3D printer as in claim 6, wherein the fixture holds the receptacle down against a relative upward force imparted by the nozzle in a direction perpendicular to the stage.

8. The 3D printer as in claim 7, wherein the receptacle is dimensioned to be larger at the outer diameter of its base than at a position above the base, and the fixture comprises holes with a maximum diameter that is smaller than the outer diameter of the base.

9. The 3D printer as in claim 6, wherein the nozzle guide is attached to the fixture.

10. The 3D printer as in claim 1, further comprising a chamber for containing a material, and wherein the chamber is in fluid communication with the nozzle and, wherein the flexible portion of the nozzle includes at least a portion of the chamber.

11. A 3D printer for extruding material into a receptacle, the printer comprising;
a. a chamber capable of containing the material, the chamber comprising at least one movable wall;
b. a mechanism for moving the wall, the mechanism being CNC controlled;
c. an opening in the chamber through which the material can pass;
d. a nozzle in fluid communication with the opening in the chamber and with an end for accepting the material from the chamber and an extruding end for extruding the material;
e. a receptacle opening for receiving the extruded material into the receptacle;
f. a stage for holding the receptacle, wherein relative movement of the nozzle and stage are CNC controlled, and;
g. a nozzle guide disposed to move the extruding end of the nozzle to the receptacle opening.

12. The 3D printer as in claim 11, wherein the nozzle guide is attached to the nozzle.

13. The 3D printer as in claim 11, wherein the nozzle guide is attached to the stage.

14. The 3D printer as in claim 11, wherein the nozzle guide comprises a part of the receptacle.

15. A method of depositing material using a 3D printer, the method comprising;
adjusting the position of the extruding opening of a nozzle to a desired position using a nozzle guide.

16. The method as in claim 15, wherein the nozzle bends due to the nozzle guide and movement that is CNC controlled.

17. The method of claim 15, wherein the nozzle guide engages a feature proximate to the desired deposition position

18. The method of claim 17, wherein said feature is the outer walls of a receptacle at a position proximate to the receptacle opening and distal from the receptacle base.

19. The method of claim 15, wherein the material is deposited into a receptacle having an opening, wherein the receptacle is held onto a stage against relative movement in a direction perpendicular to the stage and the nozzle guide comprises a part of the receptacle.

20. The method of claim 15, wherein the nozzle guide is attached to a stage.
